(19) United States
(12) Patent Application Publication
(10) Pub. No.: US 2016/0100092 A1
(43) Pub. Date: Apr. 7, 2016

(54) OBJECT TRACKING DEVICE AND TRACKING METHOD THEREOF

(71) Applicant: Fortemedia, Inc., Santa Clara, CA (US)

(72) Inventor: James Michael BOHAC, Santa Clara, CA (US)

(21) Appl. No.: 14/870,497

(22) Filed: Sep. 30, 2015

Related U.S. Application Data
(60) Provisional application No. 62/058,156, filed on Oct. 1, 2014.

(51) Int. Cl. H04N 5/232; G01S 3/801; G06F 3/16; H04N 7/18; G06T 7/20

(52) U.S. Cl. CPC H04N 5/23206; H04N 7/18; G06T 7/20; H04N 5/23296; H04N 5/23216; G06F 3/16; G01S 3/801

(57) ABSTRACT

An object tracking device and a tracking method thereof are provided. The method, adopted by an object tracking device, includes: detecting, by a first multimedia sensor, an environment to generate a first multimedia sensor output; monitoring, by a processing circuit, the first multimedia sensor output from the first multimedia sensor system; configuring, by the processing circuit, a setting for a second multimedia sensor based on the first multimedia sensor output; and monitoring, by the second multimedia sensor, the environment based on the setting to generate a second multimedia output.

### CROSS REFERENCE TO RELATED APPLICATIONS

This application claims priority of U.S. Provisional Applications No. 62/058,156, filed on Oct. 1, 2014, the entirety of which is incorporated by reference herein.

### BACKGROUND OF THE INVENTION

1. Field of the Invention

The present invention relates to an audio system, and in particular, to an object tracking device and a tracking method thereof.

2. Description of the Related Art

Audio and/or video recording is now common on a range of electronic devices, from professional video capture equipment, consumer grade camcorders and digital cameras to mobile phones and even simple devices as webcams for electronic acquisition of motion video images. Recording audio and/or video has become a standard feature on many electronic devices and an increasing number of audio/video recording functions such as object tracking has been added.

Object tracking may include audio tracking or video tracking, and is a process of locating one or more objects over time using a microphone or camera. Applications of object tracking may be found in a variety of areas such as audio recording, audio communication, video recording, video communication, security and surveillance, and medical imaging.

Therefore, an object tracking device and a tracking method thereof are needed to automatically and accurately locate a selected object during audio or video recording, leading to an increased recording quality.

### BRIEF SUMMARY OF THE INVENTION

A detailed description is given in the following embodiments with reference to the accompanying drawings.

An embodiment of a method is provided, adopted by an object tracking device, comprising: detecting, by a first multimedia sensor, an environment to generate a first multimedia sensor output; monitoring, by a processing circuit, the first multimedia sensor output from the first multimedia sensor system; configuring, by the processing circuit, a setting for a second multimedia sensor based on the first multimedia sensor output; and monitoring, by the second multimedia sensor, the environment based on the setting to generate a second multimedia output.

Another embodiment of an object tracking device is disclosed, comprising a first multimedia sensor, a processing circuit, and a second multimedia sensor. The first multimedia sensor is configured to monitor an environment to generate a first multimedia sensor output. The processing circuit is configured to monitor the first multimedia sensor output from the first multimedia sensor system, and configure a setting for a second multimedia sensor based on the first multimedia sensor output. The second multimedia sensor is configured to monitor the environment based on the setting to generate a second multimedia output.

### BRIEF DESCRIPTION OF THE DRAWINGS

The present invention can be more fully understood by reading the subsequent detailed description and examples with references made to the accompanying drawings, wherein:

FIG. 1 is a schematic diagram of an object tracking device 1 according to an embodiment of the invention;

FIG. 2 is a schematic diagram of an object tracking device 2 according to another embodiment of the invention;

FIG. 3 schematic diagram of an object tracking device 3 according to another embodiment of the invention;

FIG. 4 is a schematic diagram of an object tracking device 4 according to another embodiment of the invention; and

FIG. 5 is a flowchart of a speaker tracking method 5 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the present application, embodiments of the invention are described primarily in the context of an object device such as a cellular telephone, a smartphone, a pager, a media player, a gaming console, a Session Initiation Protocol (SIP) phone, a Personal Digital Assistant (PDA), a tablet computer, a laptop computer, and a handheld device or a computing device having two or more audio and video systems.

Various embodiments in the present application are in connection with multimedia sensors, which are transducer devices sensing multimedia contents such as image, video and audio data from the environment. The multimedia sensors may include a microphone array, an image sensor, or any sensor device with an audio or visual information capture capability.

The term “object tracking device” in the present application may include, but is not limited to, a smart phone, a smart home appliance, a laptop computer, a personal digital assistant (PDA), a multimedia recorder, or any computing device with two or more multimedia sensing systems.

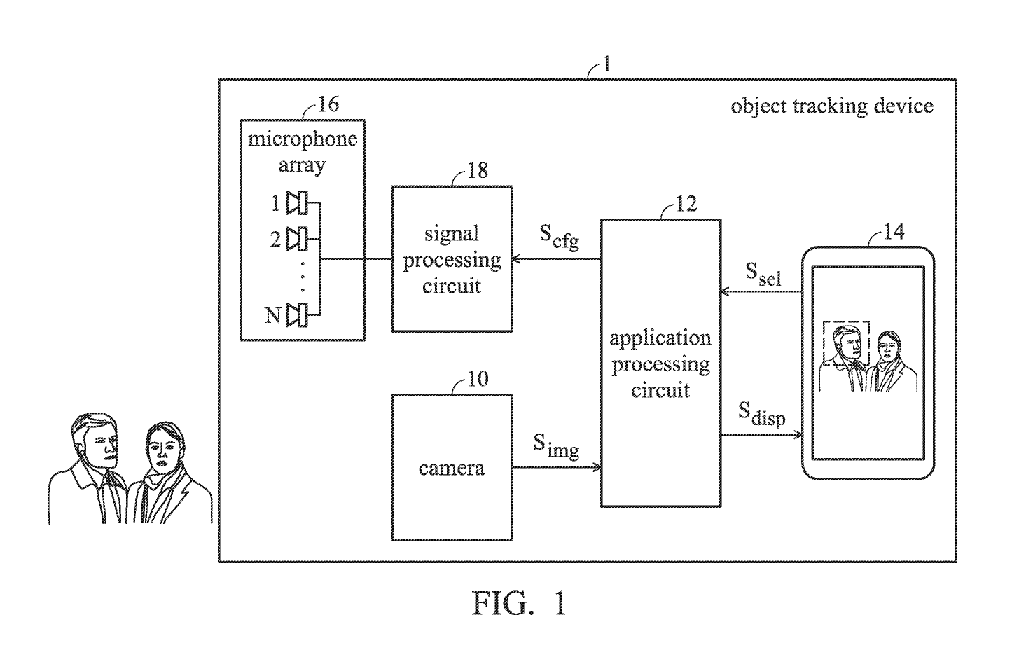

FIG. 1 is a schematic diagram of an object tracking device 1 according to an embodiment of the invention, including a camera 10, an application processing circuit 12, a touch panel 14, a microphone array 16, a signal processing circuit 18. The object tracking device 1 may include video and audio capture systems to receive video and audio data stream independently and concurrently from the environment, and receive user input signal Sₛₑₗ from the touch panel 14. The user input signal Sₛₑₗ may be a region selection or an object selection which identifies the region or object of object tracking. The object tracking device 1 may automatically locate and track the selected region or object by the microphone array 16 and the camera 10. In particular, the camera 10 may capture an image or video for a user to select the tracked region or object, and the microphone array 16 may be configured to track the selected region or object.

The microphone array 16 includes a plurality of microphones which may be configured to alter the directionality and beam forming to pick up sounds in the environment. In addition, the microphone array 16 may automatically track one or more objects according to a setting provided by the signal processing circuit 18. The setting of the microphone array 16 may be configured according to the selected region or object on the captured image from the camera 10, and may include, but is not limited to, beam angle parameters and beam width parameters, which define the directionality and beamforming of the microphone array 16.

The camera 10 may be a still image camera or a video camera, and detect images from the environment and output the detected image as an image signal S_{img} to the application processing circuit 12.

In turn, the application processing circuit 12 may display the image on the touch panel 14 for an operator of the object tracking device 1 to enter a region selection or an object selection thereon. Subsequently the application processing circuit 12 may generate the setting for the microphone array 16 according to the selected region or object on the detected image, and transmit the setting for the microphone array 16 in a configuration signal S_{cfg} to the signal processing circuit 18. The application processing circuit 12 may constantly monitor the image output from the camera 10 and the user selection output from the touch panel 14, and update the setting for the microphone array 16 whenever the detected image is changed or a user selection is amended. The region selection may be an area drawn by an operator on the image shown on the touch panel 14. The object selection may be a person or a speaker picked up by an operator from the image shown on the touch panel 14.

The signal processing circuit 18 may configure the microphone array 16 based on the setting for the microphone array 16, thereby tracking the selected region or object. When it is a selected region to be tracked, the signal processing circuit 18 may configure the beam angles and the beam widths of the lobes formed by the microphone array 16 according to the setting to provide audio detection coverage for the selected region. When it is a selected object to be tracked, the signal processing circuit 18 may configure the beam angles and the beam widths of the lobes formed by the microphone array 16 according to the setting to locate and track the selected object.

In one example, the camera 10 may initially capture an image of two persons in a room and the touch panel 14 may display the image of the two persons thereon for a user to input a selection. The user may select the left person on the image. Accordingly, the application processing circuit 12 may generate a setting for the microphone array 16 according to the selection on the image. The setting for the microphone array 16 may include a beam angle and a beam width which define the directionality and beamforming of the microphone array 16. The setting is then passed from the application processing circuit 12 to the signal processing circuit 18, which in turn control the parameters of the microphone array 16 according to the setting of microphone array 16. As a consequence, the microphone array 16 may generate a beamforming which primarily receives audio signals from the left person.

The object tracking device 1 detects an image from the environment by a camera for a user to specify a selection, so that a microphone array can operate according to a setting set up by the selection on the image, thereby locating the selected region or speaker, and recording an audio steam from the environment with an increased accuracy and recording quality.

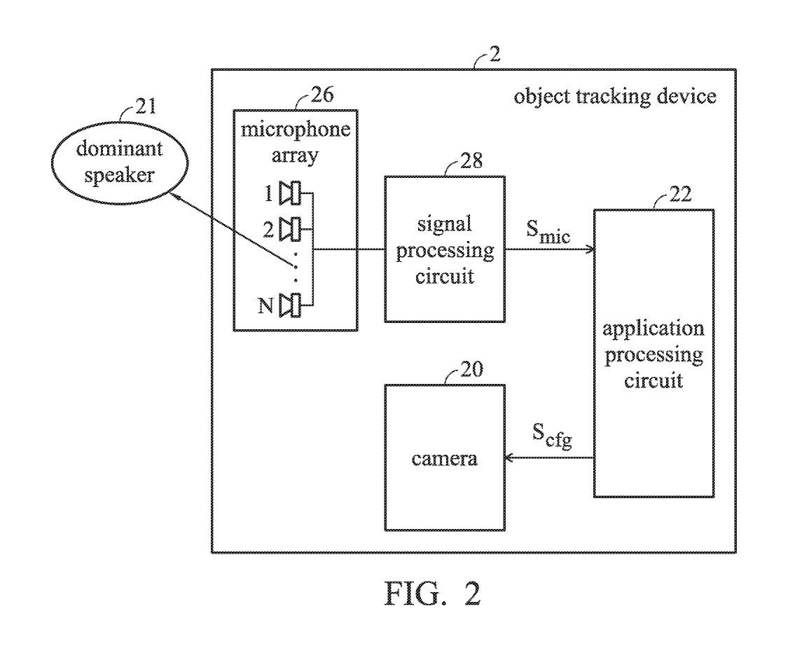

FIG. 2 is a schematic diagram of an object tracking device 2 according to another embodiment of the invention, including a camera 20, an application processing circuit 22, a microphone array 26 and a signal processing circuit 28. The object tracking device 2 may include video and audio capture systems to receive video and audio data stream independently and concurrently from the environment, automatically locate and track the selected region or object by the microphone array 26 and the camera 20. In particular, the microphone array 26 may detect a speech for the application processing circuit 22 to identify a location of a dominant speaker, and the camera 20 may be configured to track the dominant speaker in the speech.

The signal processing circuit 28 may configure the microphone array 26 according to a default setting or a user preference to monitor sounds in the environment. The default setting or the user preference may include direction and beamforming parameters of the microphone array 26.

The microphone array 26 includes a plurality of microphones configured to monitor the sounds in the environment to output an audio steam. The signal processing circuit 28 then may identify a speech from the audio stream from the microphone array 26 and determine location information of a dominant speaker from the speech, which may include a direction of the dominant speaker in relation to the object tracking device 2. For example, the signal processing circuit 28 may determine a location where a maximum volume of the speech or most of the speech is originated as the location information of the dominant speaker, represented by vertical, horizontal and/or diagonal angles with reference to the object tracking device 2. In one embodiment, the agree change unit of the vertical, horizontal and/or diagonal angles may be fixed, e.g., 10 degrees. Subsequently, the signal processing circuit 28 may deliver a microphone signal S_{mic} which contains the location information of the dominant speaker to the application processing circuit 22.

In response to the microphone signal S_{mic}, the application processing circuit 22 may generate a setting for the camera 20 according to the location information of the dominant speaker, and transmit the setting for the camera 20 in a configuration signal S_{cfg} to the camera 20. The setting for the camera 20 may include, but is not limited to, camera zoom and focus parameters which allow the camera 20 to locate the dominant speaker from the environment.

The camera 20 may capture the image or video from the environment according to the setting, and then output the captured image or video to the application processing circuit 22 for display on a monitor (not shown). Since the setting for the camera 20 is configured according to the location information of the dominant speaker, the image or video taken by the camera 20 will be zoomed at and focused on the dominant speaker, thereby tracking the dominant speaker automatically.

In one example, the microphone array 26 may initially monitor audio signals in a lecture room, and the application processing circuit 12 may identify a dominant speaker in the lecture room from the audio signals and generate a setting for the camera 20 according to the location information of the dominant speaker. The setting for the camera 20 may include a camera zoom and a camera focus which allow the camera 20 to locate the dominant speaker in the lecture room. The setting is then passed from the application processing circuit 12 to the camera 20 to operate according to the setting. As a consequence, the camera 20 may capture an image or video zooming in and focusing on the dominant speaker.

The object tracking device 2 monitors audio signals from the environment by a microphone array, so that a dominant speaker may be identified from the audio signal and a location of the dominant speaker may be estimated by an application processing circuit. A camera can operate according to a setting set up by the location of the dominant speaker, thereby outputting an image or video stream zooming in and focusing on the dominant speaker, leading to an increased accuracy and recording quality.

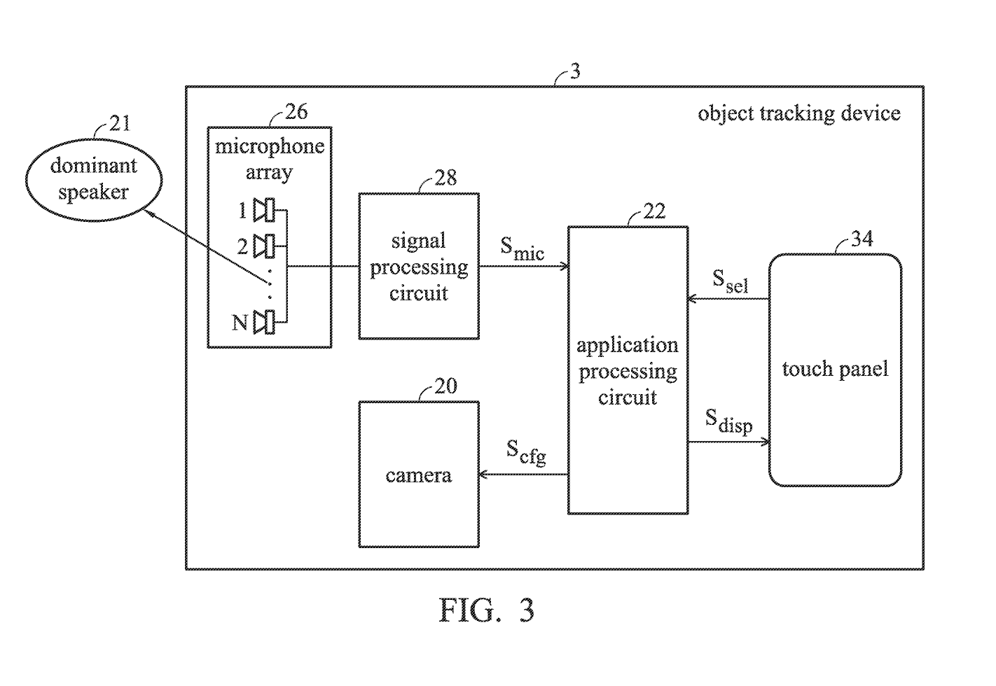

FIG. 3 schematic diagram of an object tracking device 3 according to another embodiment of the invention. The object tracking device 3 is similar to the object tracking device 2, except that an additional touch panel 34 is included to provide an option for a user to select a region or an object for tracking.

Specifically, the camera 20 may take the image or video according to a setting in a configuration signal S_{cfg}, which may be a default or configured according to location information of a dominant speaker. The camera 20 may then send the image or video to application processing circuit 22, which in turn deliver the image or video by a display signal S_{disp} to display on the touch panel 34.

When the image or video is displayed on the touch panel, a user may select an object or a region therefrom, and subsequently, the touch panel 34 may transfer the selected object or region to the application processing circuit 22 by a selection signal Sₛₑₗ. In turn, the application processing circuit 22 may determine the setting for the camera 20 according to the selected object or region in the selection signal Sₛₑₗ and/or the location information of the dominant speaker in a microphone signal S_{mic}. The setting for the camera 20 may include camera zoom and focus parameters which allow the camera 20 to locate the dominant speaker in the environment. In one embodiment, the application processing circuit 22 may determine the setting for the camera 20 according to the selected object or region, and the camera 20 may zoom in and focus on the object or region selected by a user. In another embodiment, the application processing circuit 22 may determine the setting for the camera 20 according to the selected object or region and the location information of the dominant speaker to increase accuracy of object tracking. For example, the application processing circuit 22 may determine a rough tracking range according to the location information of the dominant speaker, and then refine the tracking range according to the selected object or region. As a result, the application processing circuit 22 may configure the setting of the camera 20 according to the refined tracking range, and the camera 20 may track selected region or object according to the setting.

In one example, the microphone array 26 may initially monitor audio signals in a meeting room, and the application processing circuit 12 may identify a dominant speaker in the meeting room from the audio signals and generate a setting for the camera 20 according to the location information of the dominant speaker. The setting for the camera 20 may include a camera zoom and a camera focus which allow the camera 20 to locate the dominant speaker in the lecture room. The setting is then passed from the application processing circuit 12 to the camera 20 to operate according to the setting. As a result, the camera 20 may capture an image zooming in and focusing on the dominant speaker and the touch panel 34 may show the image in real-time for a user to specify a selection. The user may select another speaker that is next to the dominant speaker on the image (not shown). Accordingly, the application processing circuit 12 may generate a new setting for the camera 20 according to the selection on the image. The setting is gain passed to the camera 20 for which to operate according to the new setting. As a consequence, the camera 20 may capture an image zooming in and focusing on the speaker next to the dominant speaker.

The object tracking device 3 monitors audio signals from the environment by a microphone array to identify a location of the dominant speaker. Then, a camera can operate according to a setting set up by the location of the dominant speaker. In addition, the image capture by the camera may be displayed on a touch panel for a user to enter a selection to further correct, isolate, or emphasize on a person or a region. Subsequently, a new setting for the camera is generated according to the selection and the camera can operate according to the new setting, thereby outputting an image or video stream zooming in and focusing on the user selection, providing an increased accuracy and recording quality while keeping camera configuration flexibility.

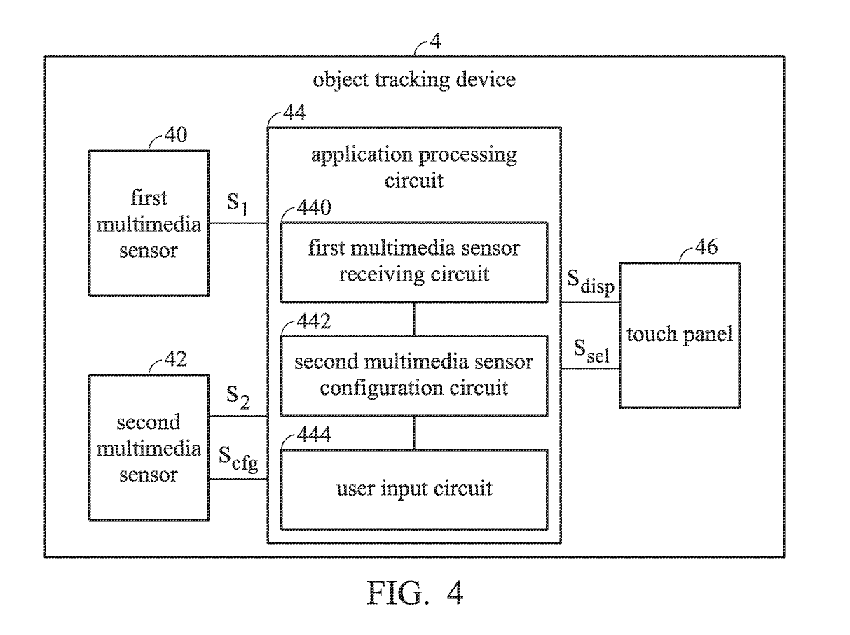

FIG. 4 is a schematic diagram of an object tracking device 4 according to another embodiment of the invention, comprising a first multimedia sensor 40, a second multimedia sensor 42, an application processing circuit 44, and a touch panel 46. The object tracking device 4 may automatically track a person or object in the view, and record the tracking data in an audio file or a video file. Specifically, The object tracking device 4 may monitor the environment with the first multimedia sensor 40, configure the setting for the second multimedia sensor 42 based on the output of the first multimedia sensor 40, and then monitor the environment with the second multimedia sensor 42. The object tracking device 4 may record the outputs of the first and second multimedia sensors 40 and 42 in a storage device (not shown) such as a flash memory, or play the audio or video streams monitored by first and second multimedia sensors 40 and 42 by a speaker (not shown) or the touch panel 44.

The first and second multimedia sensors 40 and 42 may be the same or different sensor types. The application processing circuit 44 includes a first multimedia sensor monitoring circuit 440, a second multimedia sensor configuration circuit 442, and a user input circuit.

In one embodiment, the first multimedia sensor 40 is an image capture device such as a video camera, and the second multimedia sensor 42 is a microphone array. The image capture device is configured to constantly monitor optical information which constitutes an image of the environment and output the image to the application processing circuit 44 by a first multimedia signal S1. Subsequently, the first multimedia sensor monitoring circuit 440 of the application processing circuit 44 is configured to receive the first multimedia signal S1 from the image capture device, then retrieve the image from the first multimedia signal S1, and display the image on the touch panel 46 for a user to enter a selection of an object or a region thereon. The image is transmitted from the first multimedia sensor monitoring circuit 440 to the touch panel by a display signal S_{disp}, and the selection of the object or the region is sent back to the user input circuit 444 of the application processing circuit 44 by a selection signal Sₛₑₗ. In turn, the second multimedia sensor configuration circuit 442 of the application processing circuit 44 is configured to determine a setting for the microphone array based on the selection of the image in the selection signal Sₛₑₗ. The setting for the microphone array may include, but is not limited to, beam angle parameters and beam width parameters of the microphone array. The setting of the microphone array is transmitted from the second multimedia sensor configuration circuit 442 to the microphone array by a configuration signal S_{cfg}. In response to the configuration signal S_{cfg}, the microphone array may monitor sounds in the environment based on the received setting and output the sounds to the application processing circuit 44 by a second multimedia signal S2.

In another embodiment, the first multimedia sensor 40 is a microphone array, and the second multimedia sensor 42 is an image capture device such as a video camera. The microphone array is configured to constantly monitor sounds in the environment and output the detected sound to the application processing circuit 44 by a first multimedia signal S1. Subsequently, the first multimedia sensor monitoring circuit 440 of the application processing circuit 44 is configured to receive the first multimedia signal S1 from the microphone array, then retrieve the sound data from the first multimedia signal S1 and determine location information of a dominant speaker based on the sound data. The second multimedia sensor configuration circuit 442 of the application processing circuit 44 is configured to determine a setting for the image capture device according to the location information of the dominant speaker, and transmit the setting for the image capture device to the second multimedia sensor 42 by a configuration signal S_{cfg}. In response to the configuration signal S_{cfg}, the image capture device may monitor the image from the environment based on the received setting and output the image to the application processing circuit 44 by a second multimedia signal S2. The setting for the image capture device may include, but is not limited to, camera zoom and focus parameters which enable the image capture device to locate the dominant speaker.

In one example, the second multimedia sensor configuration circuit 442 may determine the setting for the image capture device by the location information of the dominant speaker alone, and the touch panel 46 and the user input circuit 444 of the application processing circuit 44 are optional and may be eliminated from the object tracking device.

In another example, the second multimedia sensor configuration circuit 442 may determine the setting for the image capture device by the location information of the dominant speaker and a selection entered by a user, and the touch panel 46 and the user input circuit 444 in the application processing circuit 44 are required. In the case as such, the second multimedia sensor configuration circuit 442 is configured to further output the image retrieved from the second multimedia signal S2 to the touch panel 46 by a display signal S_{disp}, so that a user may enter a selection on the touch panel 46, which is subsequently sent back to the user input circuit 444 of the application processing circuit 44 by a selection signal Sₛₑₗ. In turn, the second multimedia sensor configuration circuit 442 is configured to determine a setting for the microphone array based on the selection of the image in the selection signal Sₛₑₗ.

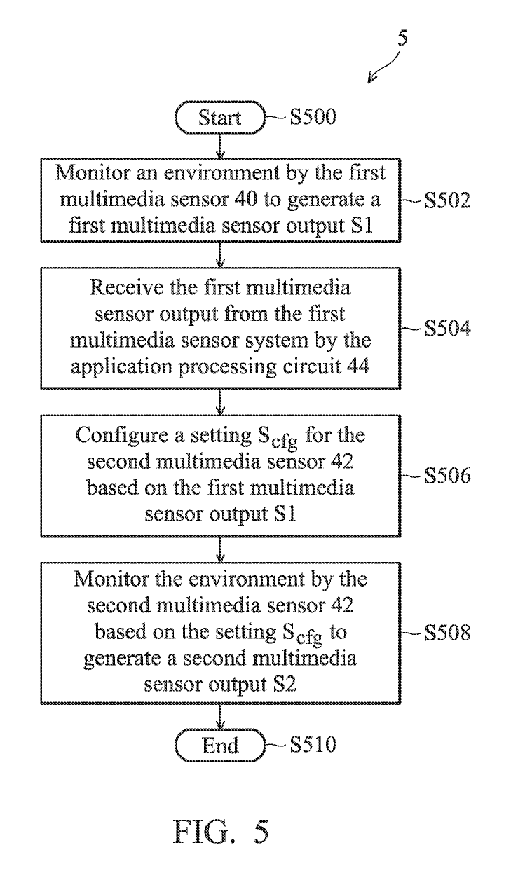

FIG. 5 is a flowchart of a speaker tracking method 5 according to an embodiment of the invention, incorporating the object tracking device 4 in FIG. 4. The speaker tracking method 5 is initialized when an object tracking application is loaded or an object tracking function is activated on the object tracking device 4 (S500).

Upon startup, the first multimedia sensor 40 may monitor an environment to generate a first multimedia sensor output S1 which contains first multimedia data (S502). The first multimedia sensor 40 may be a microphone array or an image capture device such as a video camera, and the first multimedia data may be a sound detected by the microphone array or an image captured by the image capture device. The first multimedia sensor output S1 is then sent from the first multimedia sensor 40 to the application processing circuit 44. After the application processing circuit 44 receives the first multimedia sensor output S1 (S504), it may configure a setting S_{cfg} for the second multimedia sensor 42 based on the first multimedia sensor output S1 (S506). The second multimedia sensor 42 may be a microphone array or an image capture device such as a video camera. When the second multimedia sensor 42 is a microphone array, the setting for the microphone array may be beam angle parameters and beam width parameters of the microphone array, whereas when the second multimedia sensor 42 is an image capture device, the setting for the image capture device may be camera zoom and focus parameters which enable the image capture device to locate the dominant speaker.

Next, the setting for the second multimedia sensor 42 is sent by a configuration signal S_{cfg} from the application processing circuit 44 to the second multimedia sensor 42, and the second multimedia sensor 42 may monitor the environment based on the setting in the configuration signal S_{cfg} to generate a second multimedia sensor output S2 which contains second multimedia data (S508), thereby automatically tracking an object or region. The second multimedia data may be a sound detected by the microphone array or an image captured by the image capture device.

The speaker tracking method 5 is then completed and exited (S510).

In some implementations, when one of the first multimedia sensor 40 or the second multimedia sensor 42 is an image capture device, the application processing circuit 44 may display the output image of the image capture device on the touch panel 46 to facilitate the determination of the setting of the second multimedia sensor 42. Specifically, a user may enter a selection on the image shown on the touch panel 46, which may be used by the application processing circuit 44 to determine the setting of the second multimedia sensor 42.

The object tracking device 4 and object tracking method 5 allow a second multimedia sensor to operate according to a monitoring output of a first multimedia sensor and/or user selection specified by a user, providing an increased accuracy and recording quality while keeping camera configuration flexibility.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general-purpose processor, a digital signal processor (DSP), an application-specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, units, modules, circuits and systems described herein may be implemented by way of, but not limited to, hardware, firmware, software, software in execution, and combinations thereof.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements

What is claimed is:

1. A method, adopted by an object tracking device, comprising:
detecting, by a first multimedia sensor, an environment to generate a first multimedia sensor output;
monitoring, by a processing circuit, the first multimedia sensor output from the first multimedia sensor system;
configuring, by the processing circuit, a setting for a second multimedia sensor based on the first multimedia sensor output; and
monitoring, by the second multimedia sensor, the environment based on the setting to generate a second multimedia output.

2. The method of claim 1, wherein the first multimedia sensor is a microphone array, and the second multimedia sensor is an image capture device.

3. The method of claim 2, wherein:
the step of configuring, by the processing circuit the setting for the second multimedia sensor comprises: determining, by the processing circuit, a location of a dominant speaker based on the an audio array output of the microphone array; and configuring, by the processing circuit, an image zoom and a focus of the image capture device based on the location of the dominant speaker; and
the step of the monitoring, by the second multimedia sensor, the environment based on the setting comprises: tracking, by the image capture device, the dominant speaker according to the configured image zoom and focus.

4. The method of claim 1, wherein the first multimedia sensor is an image capture device, and the second multimedia sensor is a microphone array.

5. The method of claim 4, wherein:
the step of configuring, by the processing circuit the setting for the second multimedia sensor comprises: configuring an direction and beamforming of the microphone array based on a selection on an image output by the image capture device; and
the step of the monitoring, by the second multimedia sensor, the environment based on the setting comprises: tracking, by the image capture device, the direction and the beamforming of the microphone array.

6. The method of claim 1, further comprising:
displaying, by a touch panel, the first multimedia sensor output or the second multimedia sensor output; and
receiving, by the touch panel, a selection of the displayed first or second multimedia sensor output; and
wherein the step of the configuring the setting comprises: configuring, by the processing circuit, the setting for the second multimedia sensor based on the first multimedia sensor output and the selection of the displayed first or second multimedia sensor output.

7. The method of claim 6, wherein the selection of the displayed first or second multimedia sensor output is a selected region on the displayed first or second multimedia sensor output.

8. The method of claim 6, wherein the selection of the displayed first or second multimedia sensor output is a target object on the displayed first or second multimedia sensor output.

9. An object tracking device, comprising:
a first multimedia sensor, configured to monitor an environment to generate a first multimedia sensor output;
a processing circuit, configured to monitor the first multimedia sensor output from the first multimedia sensor system, and configure a setting for a second multimedia sensor based on the first multimedia sensor output; and
the second multimedia sensor, configured to monitor the environment based on the setting to generate a second multimedia output.

10. The object tracking device of claim 9, wherein the first multimedia sensor is a microphone array, and the second multimedia sensor is an image capture device.

11. The object tracking device of claim 10, wherein:
the step of configuring, by the processing circuit the setting for the second multimedia sensor comprises: determining, by the processing circuit, a location of a dominant speaker based on the an audio array output of the microphone array; and configuring, by the processing circuit, an image zoom and a focus of the image capture device based on the location of the dominant speaker; and
the step of the monitoring, by the second multimedia sensor, the environment based on the setting comprises: tracking, by the image capture device, the dominant speaker according to the configured image zoom and focus.

12. The object tracking device of claim 9, wherein the first multimedia sensor is an image capture device, and the second multimedia sensor is a microphone array.

13. The object tracking device of claim 12, wherein:
the step of configuring, by the processing circuit the setting for the second multimedia sensor comprises: configuring an direction and beamforming of the microphone array based on a selection on an image output by the image capture device; and
the step of the monitoring, by the second multimedia sensor, the environment based on the setting comprises: tracking, by the image capture device, the direction and the beamforming of the microphone array.

14. The object tracking device of claim 9, further comprising:
displaying, by a touch panel, the first multimedia sensor output or the second multimedia sensor output; and
receiving, by the touch panel, a selection of the displayed first or second multimedia sensor output; and
wherein the step of the configuring the setting comprises: configuring, by the processing circuit, the setting for the second multimedia sensor based on the first multimedia sensor output and the selection of the displayed first or second multimedia sensor output.

15. The object tracking device of claim 14, wherein the selection of the displayed first or second multimedia sensor output is a selected region on the displayed first or second multimedia sensor output.

16. The object tracking device of claim 14, wherein the selection of the displayed first or second multimedia sensor output is a target object on the displayed first or second multimedia sensor output.
